(19) United States
(12) Patent Application Publication
(10) Pub. No.: US 2005/0067468 A1
(43) Pub. Date: Mar. 31, 2005

(54) Fluxes for flip chip assembly using water soluble polymers

(76) Inventors: Daoqiang Lu, Chandler, AZ (US); Tian-An Chen, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/676,959

(22) Filed: Sep. 30, 2003

(51) Int. Cl. B23K 31/02

(52) U.S. Cl. 228/207; 228/223

(57) ABSTRACT

An embodiment of the present invention is a technique to utilize water soluble polymer-containing flux to provide protection to low-k ILD of flip chip devices during flip chip assembly. A flux which includes at least a solvent, a water soluble monomer or polymer is applied on a substrate. A die is placed on the substrate, the die is reflowed in an oven at a reflow temperature to redistribute stress caused by coefficient thermal expansion (CTE) mismatch between the substrate and the die. The reflow temperature is higher than a melting point of the polymer.

### BACKGROUND

1. Field of the Invention

Embodiments of the invention relate to the field of semiconductor, and more specifically, to flip chip assembly.

2. Description of Related Art

Low dielectric constant (low-k) materials are used in interlayer dielectrics (ILD) in semiconductor devices to reduce propagation delay and improve device performance. Use of low-k ILD has presented challenges to device packaging applications. Among various techniques, flip chip die mounting has been the preferred approach for a wide variety of integrated circuit (IC) packaging applications. The technology has created a number of problems. One particular problem in flip chip assembly is the stress induced during chip attachment, causing de-lamination, cracking, or other damages to the low-k ILD inside the die. The stress is mainly caused by coefficient thermal expansion (CTE) mismatch between the die and the substrate.

Existing techniques are inadequate to solve this problem. High residue and high modulus flux can only provide marginal protection for low-k ILD and cannot provide full protection for future low-k ILD materials. In addition, any flux residue may cause downstream capillary underfill process problems and negatively impact device reliability.

### BRIEF DESCRIPTION OF THE DRAWINGS

The invention may best be understood by referring to the following description and accompanying drawings that are used to illustrate embodiments of the invention.

In the drawings:

FIG. 1 is a diagram illustrating a system in which one embodiment of the invention can be practiced.

FIG. 2A is a diagram illustrating a flux dispensing according to one embodiment of the invention.

FIG. 2B is a diagram illustrating chemical structures of polymers according to one embodiment of the invention

FIG. 2C is a diagram illustrating a die placement according to one embodiment of the invention.

FIG. 2D is a diagram illustrating a reflow according to one embodiment of the invention.

FIG. 2E is a diagram illustrating a de-fluxing according to one embodiment of the invention.

FIG. 2F is a diagram illustrating an under-fill dispensing according to one embodiment of the invention.

FIG. 3A is a diagram illustrating a reflow temperature profile for flux having monomer according to one embodiment of the invention.

FIG. 3B is a diagram illustrating a reflow temperature profile for flux having polymer according to one embodiment of the invention.

FIG. 4 is a flowchart illustrating a process for flip-chip assembly according to one embodiment of the invention.

FIG. 5 is a flowchart illustrating a process for reflow according to one embodiment of the invention.

### DESCRIPTION

An embodiment of the present invention is a technique to utilize water soluble polymer-containing flux to protect low-k ILD of flip chip devices during assembly. A flux which includes at least a solvent and one of a water soluble monomer or a water soluble polymer or a traditional flux agent is applied on substrate After a die is placed on the flux on the substrate, the die is reflowed in a reflow oven at a reflow temperature which is higher than the melting point of the polymer to form solder joints, and during cooling, the molten polymer solidifies to redistribute stress caused by coefficient thermal expansion (CTE) mismatch between the substrate and the die.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a procedure, a method of manufacturing or fabrication, etc.

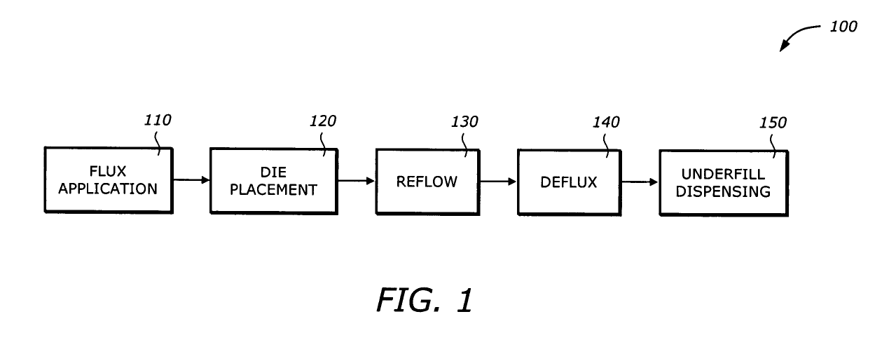

FIG. 1 is a diagram illustrating a system 100 in which one embodiment of the invention can be practiced. The system 100 includes a flux application 110, a die placement 120, a reflow 130, a de-fluxing 140, and an under-fill dispensing 150.

The flux application 110 applies or dispenses flux on a substrate which has pre-fabricated solder bumps. The flux contains at least a water soluble monomer or polymer. The flux application 110 may be a stencil printing fluxing, a spray fluxing, or any other suitable methods. The die placement 120 then picks, aligns and places a die onto the substrate. The die is an integrated circuit (IC) device or a chip. The die may be picked from a feeder, tape and reel and is positioned to align with the solder bumps on the substrate. The reflow 120 forms the solder joints from the solder bumps and the flux in a reflow oven heated at a reflow temperature. The de-fluxing 140 removes the flux residues and cleans the solder joints. The under-fill dispensing 150 dispenses under-fill material around the die. The under-fill is allowed to flow and fill the gap between the flip-chip and the substrate.

The flux used in the flux application 110 includes a solvent and at least one of a water soluble monomer or polymer and a traditional flux agent if the monomer or polymer does not have fluxing capability. The use of the water soluble monomer or polymer in the flux offers a number of advantages. First, it provides a high mechanical strength, or modulus, and high level residue to offset the CTE mismatch between the die and the substrate. This will lead to better protection for low-k ILD. Second, the cleaning process is facilitated. The flux residue can be completely removed by hot de-ionized (DI) water leading to significant improvement in device reliability. Third, it allows the use of capillary under-fill without void and flux residue-related problems. Fourth, it is compatible with conventional assembly process from flux printing to chip attachment, to de-flux or cleaning, and then to capillary under-fill with no or minimum impact.

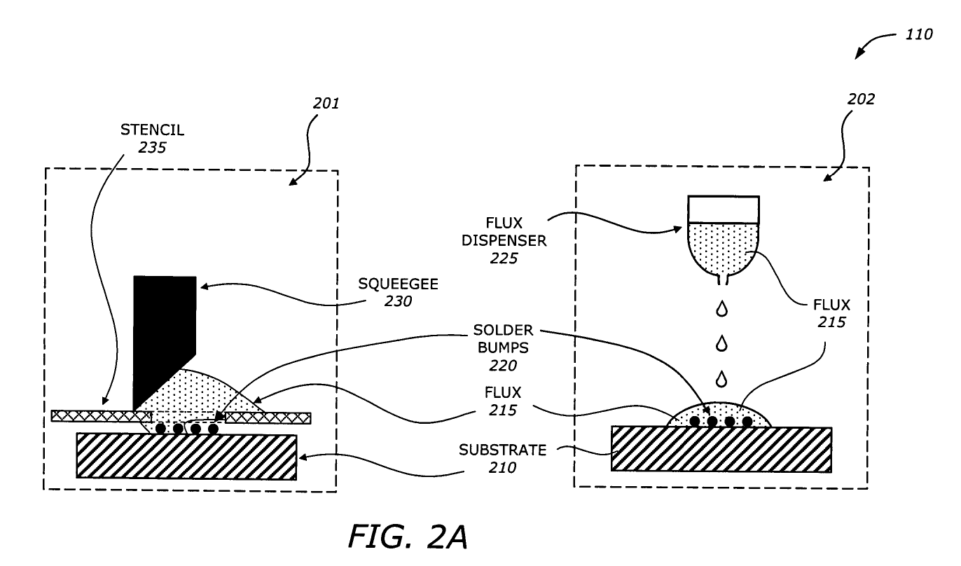

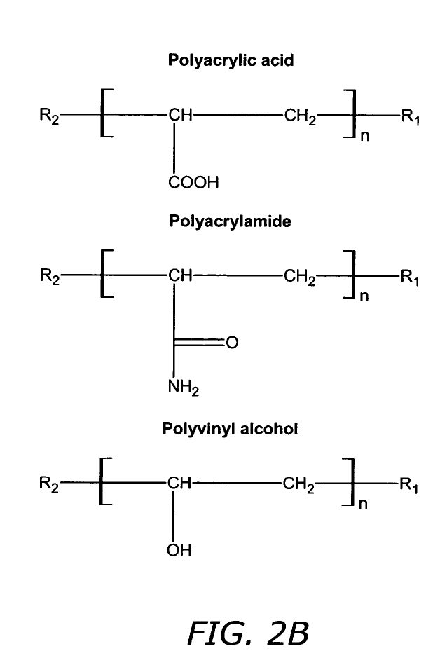

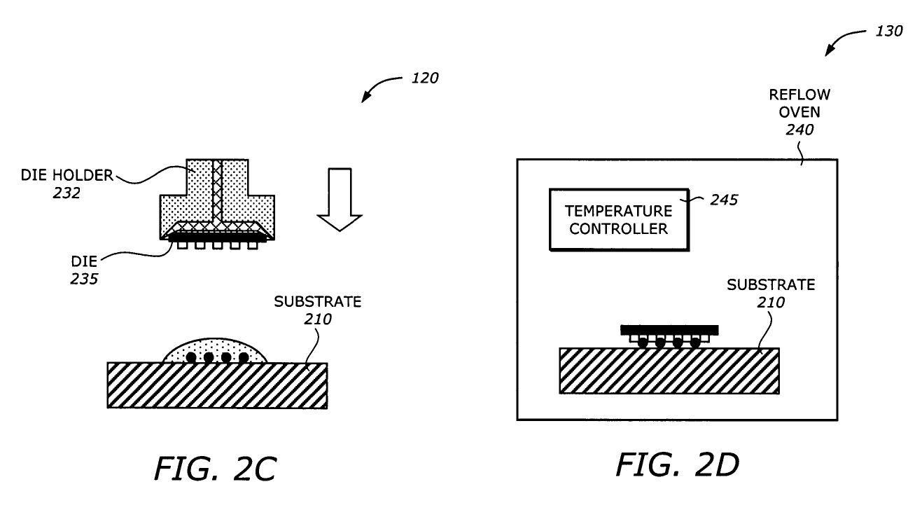

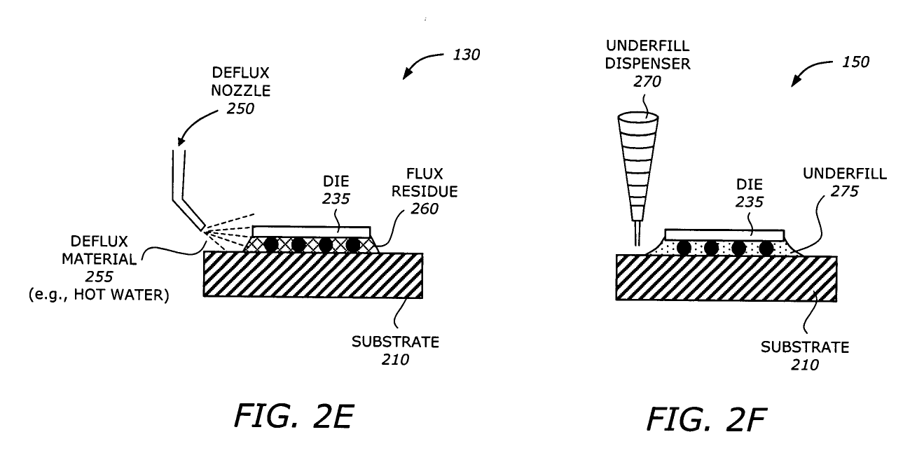

FIG. 2A is a diagram illustrating a flux application 110 according to one embodiment of the invention. The flux application 110 may be performed in one of two processes, process 201 and process 202.

In process 201, the flux 215 is printed on the pre-fabricated solder bumps 215 on a substrate 210 utilizing a stencil 235 and a squeegee 230. In process 202, the flux 215 is dispensed onto the pre-fabricated solder bumps on a substrate 210 utilizing a dispenser 225.

In both processes, the flux 215 includes a solvent, a water soluble polymer or monomer, a traditional flux agent such as organic acid if the polymer or monomer does not have fluxing capability, and other additives. The solvent may be organic solvent, water, or mixtures. The additives include surfactant, wetting agent, and viscosity modifier. When a monomer is used, it will polymerize to form a polymer during the reflow 120. The polymer or the polymerized monomer has a melting point lower than the reflow temperature so that it will not affect the solder joint formation during the reflow process. The water soluble polymer may be any one of a polyacrylic acid, a polyacrylamide, a polyvinyl alcohol, a modified starch, and a modified cellulose.

FIG. 2B is a diagram illustrating chemical structures of polymers according to one embodiment of the invention.

The polyacrylic acid may be used as a flux agent while the polyacrylamide and polyvinyl alcohol may need to be combined with a traditional fluxing agent such as Rosin to be used as a flux agent. The polymers with a melting temperature below 183° C. can be used for Sn/Pb eutectic solder joint while those with a melting point below 200° C. can be used for lead-free solder joint like Sn/Ag, Sn/Cu, or Sn/Ag/Cu. For example, polyacrylamide and polyvinyl alcohol have melting points of 84° C. and 200° C., respectively. Therefore, polyacrylamide can be used for flip chip assembly with eutectic SnPb solder, and polyvinyl alcohol can be used for flip chip assembly with lead-free SnAg solder.

The use of the above polymers offer a number of advantages. First, there is a high polymer residue level left after the chip attachment process. Second, there is a high adhesion of the polymeric residue to both the die and the substrate surfaces. Third, there is a high modulus (greater than 1 GPa) of the polymeric residue to provide the mechanical strength and redistribute the internal stress generated due to the CTE mismatch between the die and substrate after assembly and protect the weak low-k ILD of the die. Fourth, the polymeric residue can be dissolved in hot de-ionized (DI) water and removed by hot DI water cleaning. This complete removal of the residue increases the device reliability significantly.

FIG. 2C is a diagram illustrating a die placement 120 according to one embodiment of the invention.

A die holder 232 holds a die 235 and places it onto the pre-fabricated solder bumps 220 on the substrate 210. The die 235 is an integrated circuit (IC) or a chip. It may be picked from a feeder mechanism, such as waffle pack feeders, tape and reel, surf tape or a direct wafer feeder. The bumps 236 of the die 235 are aligned with the solder bumps 220 on the substrate 210 and the die 235 is then placed onto the substrate 210.

FIG. 2D is a diagram illustrating a reflow process 130 according to one embodiment of the invention.

The assembly including the die 235 and the substrates 210 together with the flux 215 is placed in a reflow oven 240. The reflow oven 240 has a temperature controller 245 to control the reflow temperature. During reflow, the reflow temperature is increased to a maximum temperature and then decreased to cool down. At the increasing temperature, the metal oxide on the substrate and die bumps is removed by the polymer acid or additive acid. The solder joints are then formed while the polymer is in the melting state, e.g., in liquid form. During cooling down, the polymer is hardened or solidified. The stress in the solder bumps caused by CTE mismatch is re-distributed by the solidified polymer. The low-k ILD is then protected from damage by the high modulus polymer residue.

FIG. 2E is a diagram illustrating a de-fluxing 140 according to one embodiment of the invention.

After the reflow 130, there is flux residue 260 left between the die 235 and the substrate 210. The flux residue consists of primarily the solid water soluble polymer, residue for the additive acid, and other residues from the additives. A de-flux machine 250 sprays a de-flux material 255 into the die and substrate assembly to remove the flux residue 260. The de-flux material 255 may be hot DI water. The polymeric residue 260 is dissolved easily in hot DI water and is completely removed from the die assembly.

FIG. 2F is a diagram illustrating an under-fill dispensing 150 according to one embodiment of the invention.

An under-fill dispenser 270 dispenses an under-fill 275 around the die 235. The under-fill 275 fills the gap between the die 235 and the substrate 210 through capillary action.

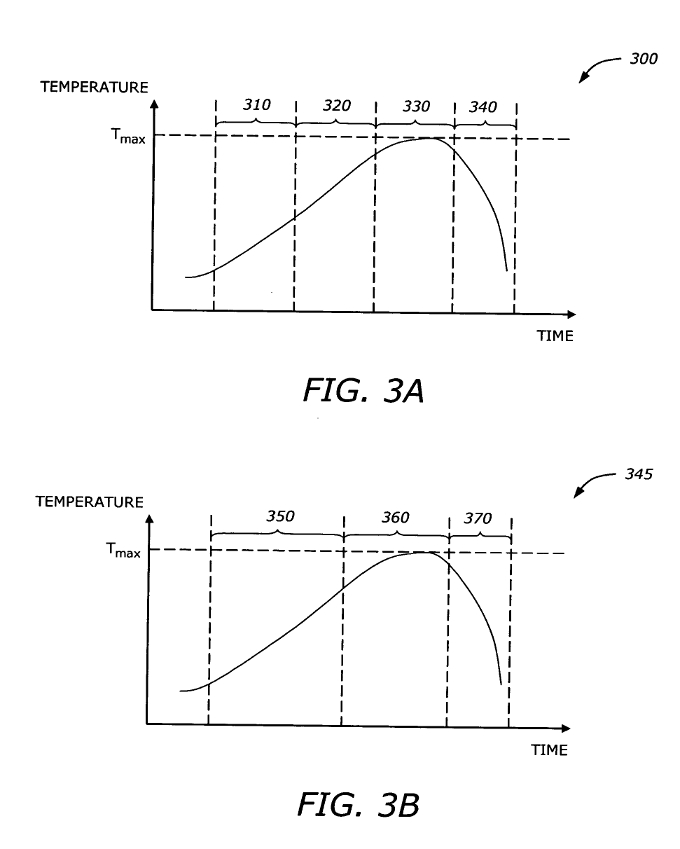

FIG. 3A is a diagram illustrating a reflow temperature profile 300 for flux having monomer according to one embodiment of the invention. The reflow temperature profile 300 includes regions 310, 320, 330, and 340.

The regions 310 and 320 correspond to increasing temperature. During the region 310, the monomer in the flux reacts to form a solid polymer and the flux mixture removes the metal oxide from the solder bumps. During the region 320, the solid polymer melts into a polymer liquid.

The region 330 corresponds to approximately constant temperature. During this region, the solder bumps melt and form solder joints. The region 340 corresponds to decreasing temperature, or cooling down. During the region 340, the solder joints solidify. The molten polymer flux also solidifies to re-distribute the stress generated by the CTE mismatch between the die and the substrate. This will provide protection to low-k ILD.

FIG. 3B is a diagram illustrating a reflow temperature profile 345 for flux having polymer according to one embodiment of the invention. The reflow temperature profile 345 includes regions 350, 360, and 370.

The region 350 correspond to increasing temperature. During the region 350, the flux mixture removes the metal oxide from the solder bumps, and the solid polymer melts into a polymer liquid.

The region 360 corresponds to approximately constant temperature. During this region, the solder bumps melt and form solder joints. The region 370 corresponds to decreasing temperature, or cooling down. During the region 370, the solder joints solidify. The molten polymer flux also solidifies to re-distribute the stress generated by the CTE mismatch between the die and the substrate. This will provide protection to low-k ILD.

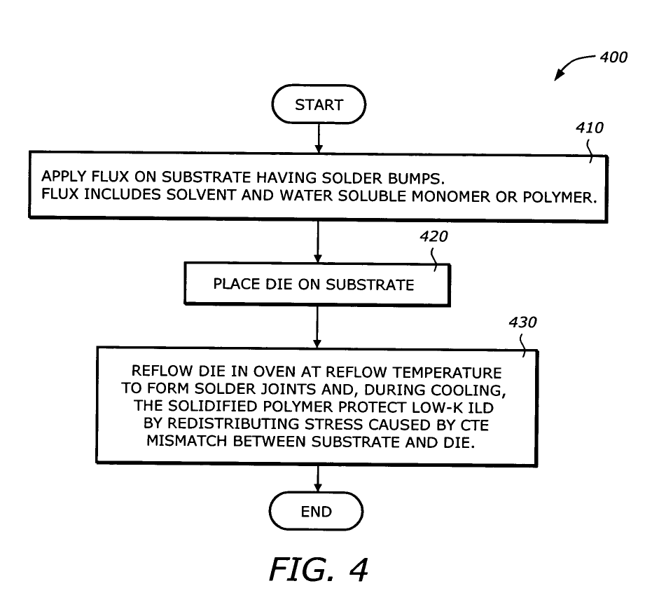

FIG. 4 is a flowchart illustrating a process 400 for flip-chip assembly according to one embodiment of the invention.

Upon START, the process 400 applies a flux on a substrate which may have pre-fabricated solder bumps (Block 410). The flux includes a solvent, a water soluble monomer or polymer, or a traditional flux agent.

Next, the process 400 places a die on the substrate (Block 420). The die is aligned with the substrate. Then, the process 400 reflows the die assembly in a reflow over at a reflow temperature to form electrical interconnections between the die and substrate while the polymer is in molten state, and during cooling down, the polymer solidifies, re-distribute the stress caused by the CTE mismatch between the die and the substrate (Block 430). The reflow temperature is higher than the melting point of the polymer. The process 400 is then terminated.

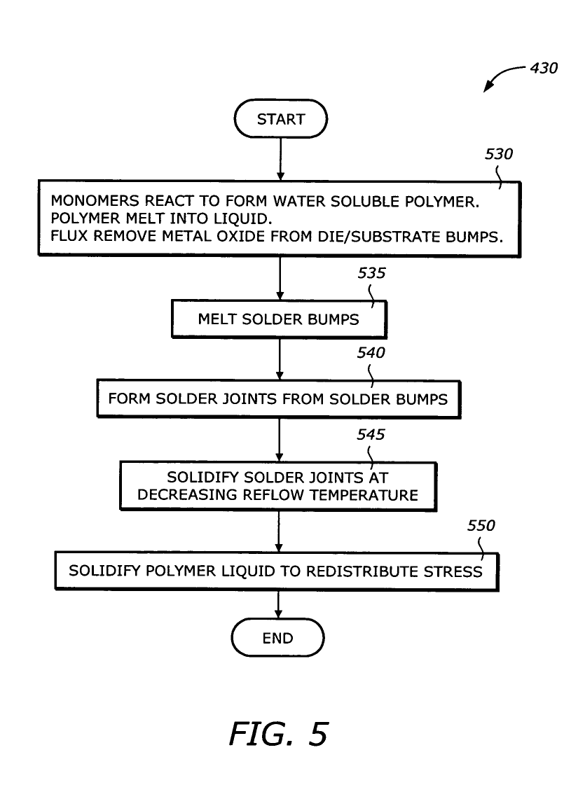

FIG. 5 is a flowchart illustrating a reflowing process 430 according to one embodiment of the invention.

Upon START, several processes may happen simultaneously (block 510). These processes include monomers reacting to form polymer, flux removed of metal oxide, solvent vaporization, and a polymer melting. Next, the process 430 melts the solder bumps (Block 535). Next, the process 430 forms solder joints from the solder bumps (Block 540).

Then, the process 430 solidifies the solder joints at decreasing reflow temperature (Block 545), e.g., during cooling. Next, the process 550 solidifies the polymer liquid to redistribute the stress (Block 550) and is then terminated.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. A method comprising:
applying a flux on a substrate having solder bumps, the flux including at least a solvent and a water soluble monomer or a water soluble polymer;
placing a die on the substrate; and
reflowing the die in an oven at a reflow temperature to redistribute stress caused by coefficient thermal expansion (CTE) mismatch between the substrate and the die, the reflow temperature being higher than a melting point of the polymer.

2. The method of claim 1 wherein applying the flux comprises:
applying the flux including the water soluble polymer being one of a polyacrylic acid, a polyacrylamide, a polyvinyl alcohol, a starch, and a cellulose.

3. The method of claim 1 wherein applying the flux comprises:
applying the flux including at least an organic solvent and the water soluble monomer.

4. The method of claim 1 wherein applying the flux comprises:
applying the flux including at least an organic solvent and the water soluble polymer.

5. The method of claim 1 wherein reflowing the die comprises:
vaporizing the solvent at an increasing reflow temperature;
melting the polymer into polymer liquid; and
removing metal oxide from the solder bumps.

6. The method of claim 5 wherein reflowing the die further comprises:
melting the solder bumps;
forming solder joints from the melted solder bumps;
solidifying the solder joints at a decreasing reflow temperature; and
solidifying the polymer liquid to redistribute the stress.

7. The method of claim 1 wherein reflowing the die comprises:
vaporizing the solvent at an increasing reflow temperature;
reacting the monomer to form solid polymer;
melting the solid polymer into polymer liquid; and
removing metal oxide from the solder bumps.

8. The method of claim 7 wherein reflowing the die further comprises:
melting the solder bumps;
forming solder joints from the melted solder bumps;
solidifying the solder joints at a decreasing reflow temperature; and
solidifying the polymer liquid to redistribute the stress.

9. The method of claim 1 further comprising:
de-fluxing the die to remove polymer residue; and
dispensing an underfill material into gap between the die and the substrate.

10. The method of claim 9 wherein de-fluxing comprises:
dissolving the polymer residue by hot water.

11. A method comprising:
mixing a solvent with at least a water soluble monomer or a water soluble polymer to form a flux; and
applying the flux to a die assembly including a die and a substrate to redistribute stress caused by coefficient thermal expansion (CTE) mismatch between the substrate and the die.

12. The method of claim 11 wherein mixing comprises:
mixing the solvent with the water soluble polymer being one of a polyacrylic acid, a polyacrylamide, a polyvinyl alcohol, a starch, and a cellulose.

13. The method of claim 111 wherein mixing comprises:
mixing an organic solvent and the water soluble monomer.

14. The method of claim 11 wherein mixing comprises:
mixing an organic solvent and the water soluble polymer.

15. The method of claim 11 wherein applying the flux comprises:
reflowing the die assembly in an oven at a reflow temperature, the reflow temperature being higher than a melting point of the polymer.

16. The method of claim 15 wherein reflowing the die assembly comprises:
increasing the reflow temperature to melt the polymer into polymer liquid and to form solder joints from the solder bumps; and
decreasing the reflow temperature to solidify the solder joints and the polymer liquid.

17. The method of claim 15 wherein reflowing the die assembly comprises:
increasing the reflow temperature to react the monomer to form solid polymer and to form solder joints from the solder bumps; the solid polymer being melted into polymer liquid, and
decreasing the reflow temperature to solidify the solder joints and the polymer liquid.

18. The method of claim 11 further comprising:
de-fluxing the die assembly to remove polymer residue.

19. The method of claim 18 wherein de-fluxing comprises:
dissolving the polymer residue by hot water.

20. The method of claim 18 further comprising:
dispensing an underfill material into a gap between the die and the substrate.

21. A system comprising:
a flux dispenser to apply a flux on a substrate having solder bumps, the flux including at least a solvent and a water soluble monomer or a water soluble polymer;
a die placement assembly to place a die on the substrate; and
a reflow oven to reflow the die at a reflow temperature to redistribute stress caused by coefficient thermal expansion (CTE) mismatch between the substrate and the die, the reflow temperature being higher than a melting point of the polymer.

22. The system of claim 21 wherein the water soluble polymer is one of a polyacrylic acid, a polyacrylamide, a polyvinyl alcohol, a starch, and a cellulose.

23. The system of claim 21 wherein the flux includes at least an organic solvent and the water soluble monomer.

24. The system of claim 21 wherein the flux includes at least an organic solvent and the water soluble monomer.

25. The system of claim 21 wherein the reflow oven vaporizes the solvent at an increasing reflow temperature, melts the polymer into polymer liquid, and removes metal oxide from the solder bumps.

26. The system of claim 25 wherein the reflow oven further melts the solder bumps, forms solder joints from the melted solder bumps, solidifies the solder joints at a decreasing reflow temperature, and solidifies the polymer liquid to redistribute the stress.

27. The system of claim 21 wherein the reflow oven vaporizes the solvent at an increasing reflow temperature, reacts the monomer to form solid polymer, melts the solid polymer into polymer liquid, and removes metal oxide from the solder bumps.

28. The system of claim 27 wherein the reflow oven further melts the solder bumps, forms solder joints from the melted solder bumps, solidifies the solder joints at a decreasing reflow temperature, and solidifies the polymer liquid to redistribute the stress.

29. The system of claim 21 further comprising:
a de-fluxing dispenser to de-flux the die to remove polymer residue; and
an underfill dispenser to dispense an underfill material into a gap between the die and the substrate.

30. The system of claim 21 wherein the de-flux dispenser dissolves the polymer residue by hot water.
